(19) United States
(12) Patent Application Publication
(10) Pub. No.: US 2003/0062295 A1
(43) Pub. Date: Apr. 3, 2003

(54) Self-cleaning filter assembly

(76) Inventors: Steve Martin Brooks, Surrey (GB); Robert Ivan John Wiedemann, Middlesex (GB); David Goodwin, Surrey (GB)

Correspondence Address: William H. Oldach III, Vorys, Sater, Seymour and Pease LLP, Eleventh Floor, 1828 L Street, N.W., Washington, DC, 20036-5109, US

(21) Appl. No.: 10/255,625

(22) Filed: Sep. 27, 2002

(30) Foreign Application Priority Data
Oct. 3, 2001 (GB) GB 0123761.9

(51) Int. Cl. B01D 35/16

(52) U.S. Cl. 210/108; 210/110; 210/314; 210/335; 210/443

(57) ABSTRACT

A self-cleaning assembly has an enclosed casing with a movable member/piston and a filter therein, the casing having an inlet and a first outlet for liquid supplied thereto and a second outlet for removing liquid containing contaminant from the casing. The filter assembly is constructed and arranged to provide, in a normal operating mode, a liquid flow path through the filter in a first direction between the inlet and the outlet and, in a cleaning mode, to provide a liquid flow path in a second direction between the inlet and the second outlet. The movable member compresses the filter during the liquid flow in the second direction and contaminant is released therefrom for removal from the filter assembly via the second outlet.

This invention relates to a self-cleaning filter assembly and more particularly but not exclusively to a filter assembly for use with a pond pump.

A pond filter usually includes an open cell foam or similar compressible filter media designed to remove contaminants and debris from water pumped through the filter. The filter media can soon become blocked with a consequent loss in filtering efficiency. The filter then needs to be disassembled so that the filter media can be removed and cleaned. This is both messy, time consuming and can frequently lead to the destruction of beneficial bacteria in the filter medium.

It is therefore an object of the invention to provide a filter assembly which can be efficiently cleaned without removal of the filter medium therefrom.

According to the invention, there is provided a self-cleaning filter assembly comprising an enclosed casing with a movable member/piston and a filter therein, the casing having an inlet and a first outlet for liquid supplied thereto and a second outlet for removing liquid containing contaminant from the casing, the filter assembly being constructed and arranged to provide, in its normal operating mode, a liquid flow path through the filter in a first direction between the inlet and the outlet and, in a cleaning mode, to provide a liquid flow path in a second direction between the inlet and the second outlet whereby the movable member compresses the filter during the liquid flow in said second direction and contaminant is released therefrom for removal from the filter assembly via the second outlet.

Preferably the liquid flow through the casing from the inlet to the outlets is controlled by valve means which can comprise one or more separate valve assemblies.

In the preferred embodiment, a main tube is provided in the casing to feed liquid from the inlet to the bottom thereof, the main tube having an outlet located adjacent the bottom of the casing. Conveniently a deflector is positioned directly opposite the main tube outlet, the deflector being shaped to deflect the liquid flow from the main tube outlet radially outwardly and upwardly into the casing. Conveniently the deflector is a saucer-shaped member.

Preferably the main feed tube is located centrally in the casing and the casing has a perforated floor spaced from the bottom of the casing to provide a settlement chamber for contaminant flushed from the filter, the main tube outlet opening into said chamber.

Preferably the filter rests on the perforated floor but is axially movable in the housing along the main tube. The filter can comprise a single element but preferably comprises a plurality of separate filter elements stacked one on top of each other. In the preferred embodiment, the filter comprises two filter elements made, for instance, of an open cell polyethylene foam material.

The movable member/piston is preferably made of a closed cell flexible foam such as neoprene. It can however be made of a rigid material with a flexible edge seal made, for instance, of rubber. Alternatively, the piston can include a one way valve or valves therein which allows normal upward liquid flow therethrough but not downward reverse flow. The movable member/piston needs to make an edge seal with the housing during reverse flow so that the liquid pressure build-up moves the piston axially in the housing to compress the filter and squeeze contaminant therefrom.

Preferably a secondary tube extends through the casing and includes means to connect the settlement chamber with the second outlet.

Conveniently, a movable perforated container is mounted around the main and secondary tubes and is slidable therealong, said chamber normally resting on the top filter element.

In the preferred embodiment, an abutment is provided in the casing adjacent the upper end thereof to limit axial movement of the perforated container towards the top of the casing.

Preferably the valve means comprises a valve assembly mounted in a chamber in the casing, the arrangement being such that liquid supplied to or leaving the casing is fed through the chamber containing the valve assembly, the chamber having a wall with ports therein and a floor with a port therein communicating with the interior of the casing.

In the preferred embodiment, when the valve assembly is in a first position liquid is fed from the inlet to the interior of the casing via ports in the wall of the valve chamber, the port in the floor of the valve chamber allowing liquid to leave the casing and flow to only the first liquid outlet. The valve assembly is however movable to a second position in which liquid from the inlet is fed to the interior of the casing through the port in the floor of the valve chamber, liquid containing contaminant being fed from the interior of the casing to only the second liquid outlet via ports in the valve chamber wall. The valve assembly is also movable to a third position in which liquid is fed from the liquid inlet to the interior of the casing via ports in the wall of the valve chamber, liquid containing contaminant being fed from the interior of the casing to only the second liquid outlet via the port in the floor of the valve chamber and a port in the wall thereof.

In the preferred embodiment, the valve assembly is rotatably mounted in the valve chamber, the valve having portions movable to obturate the ports in the chamber wall to vary the direction of liquid flow when the valve is in said first, second and third positions. Preferably the valve also has a portion which splits the liquid flow through the port in the floor of the valve chamber.

A preferred embodiment of the invention will now be described, by way of example only, with reference to the accompanying drawings, in which:

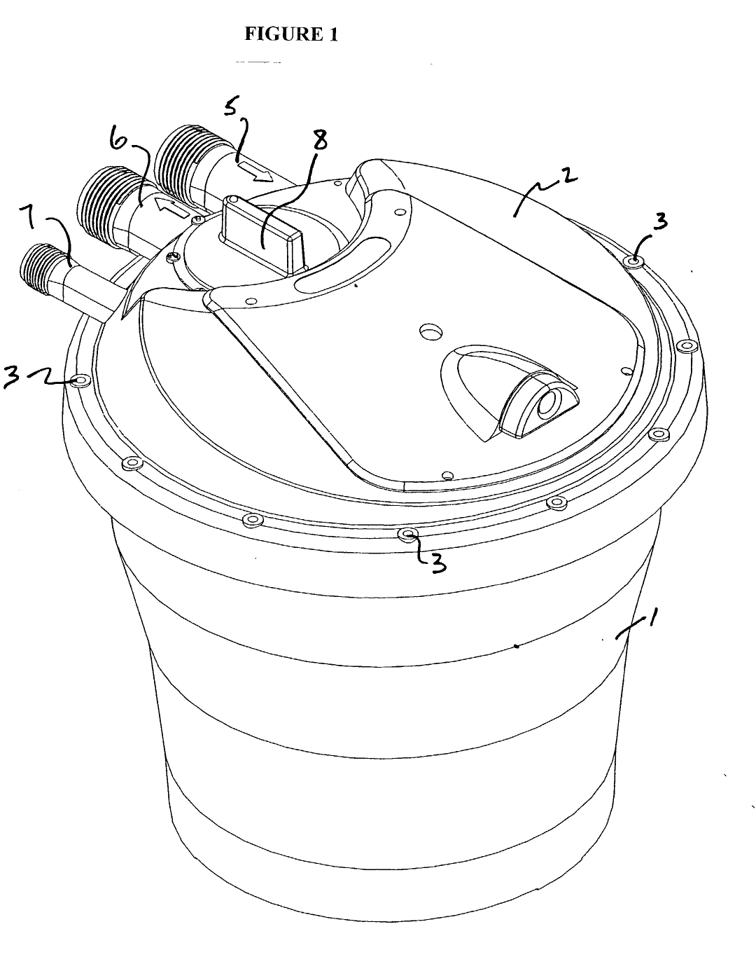

FIG. 1 is a perspective view of a filter assembly of the present invention;

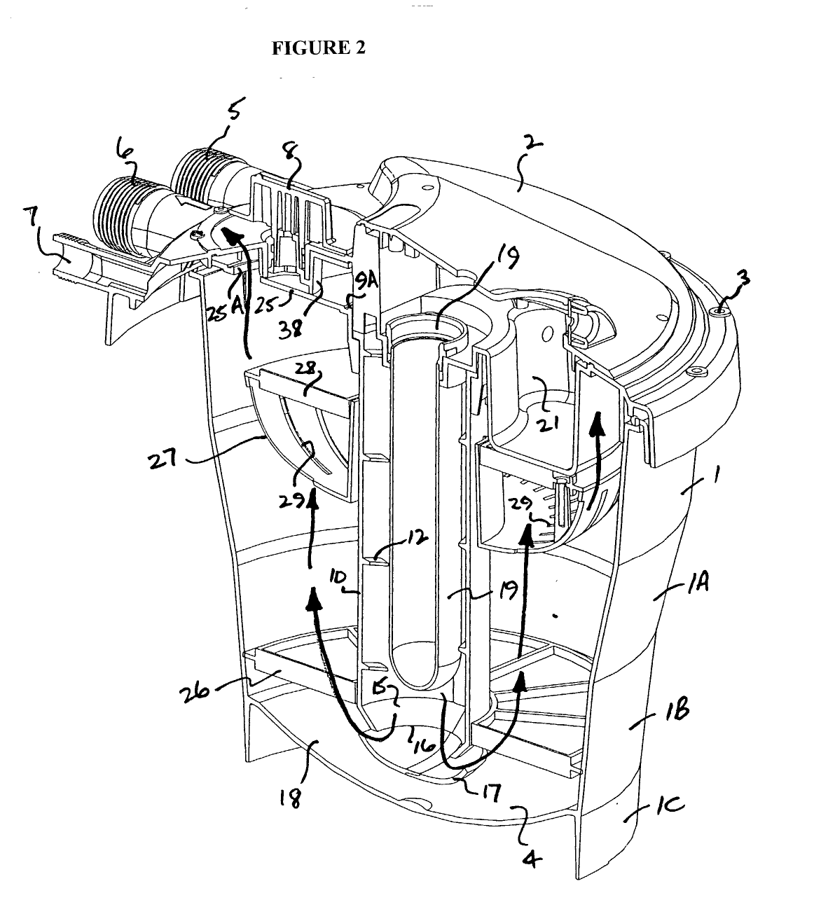

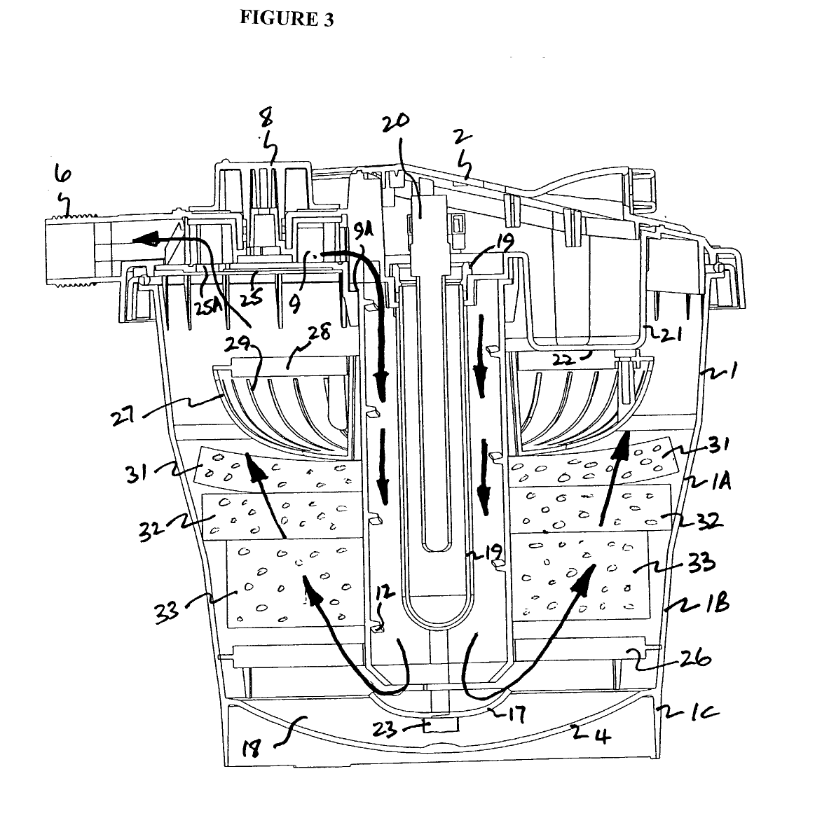

FIG. 2 is a perspective view in cross section of the filter assembly shown in FIG. 1;

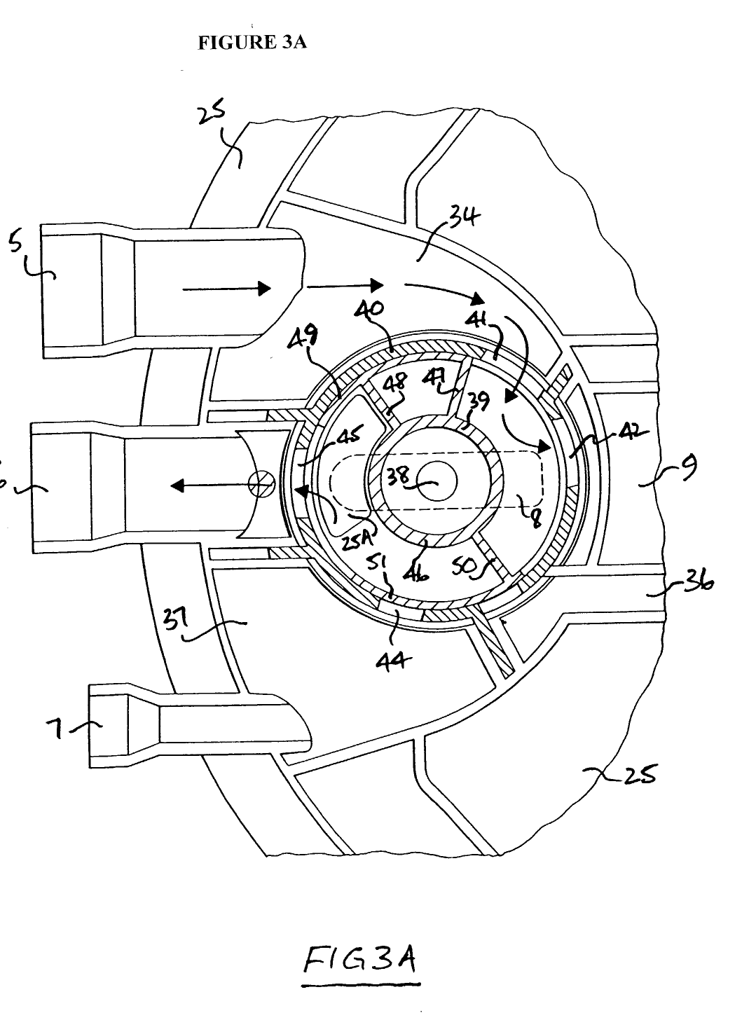

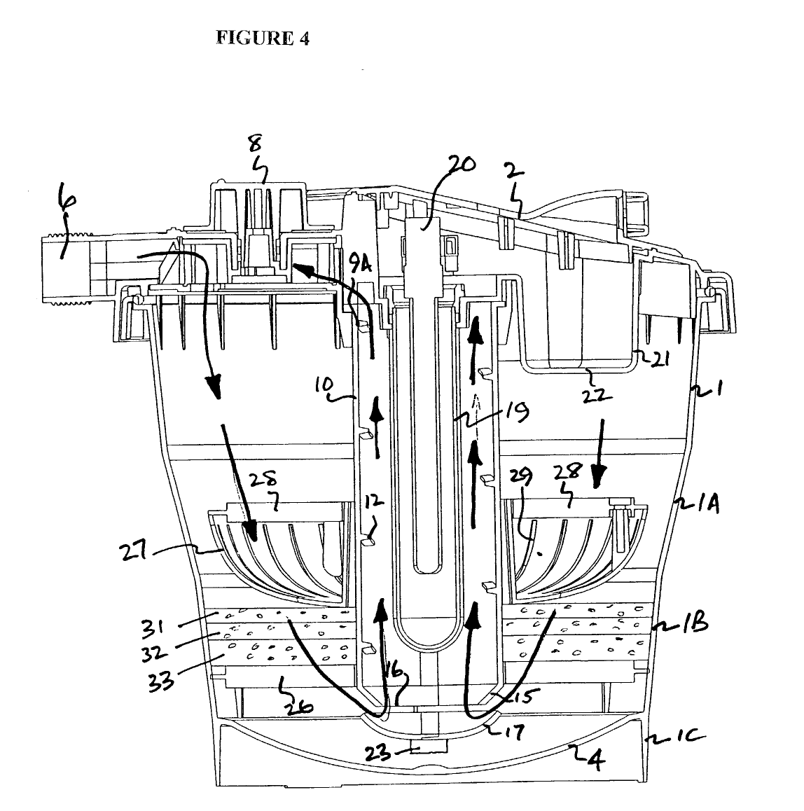

FIG. 3 is a cross section of the filter assembly shown in FIGS. 1 and 2 during normal running;

FIG. 3A is a cross sectional plan view of the valve shown in FIG. 3 in its normal running mode;

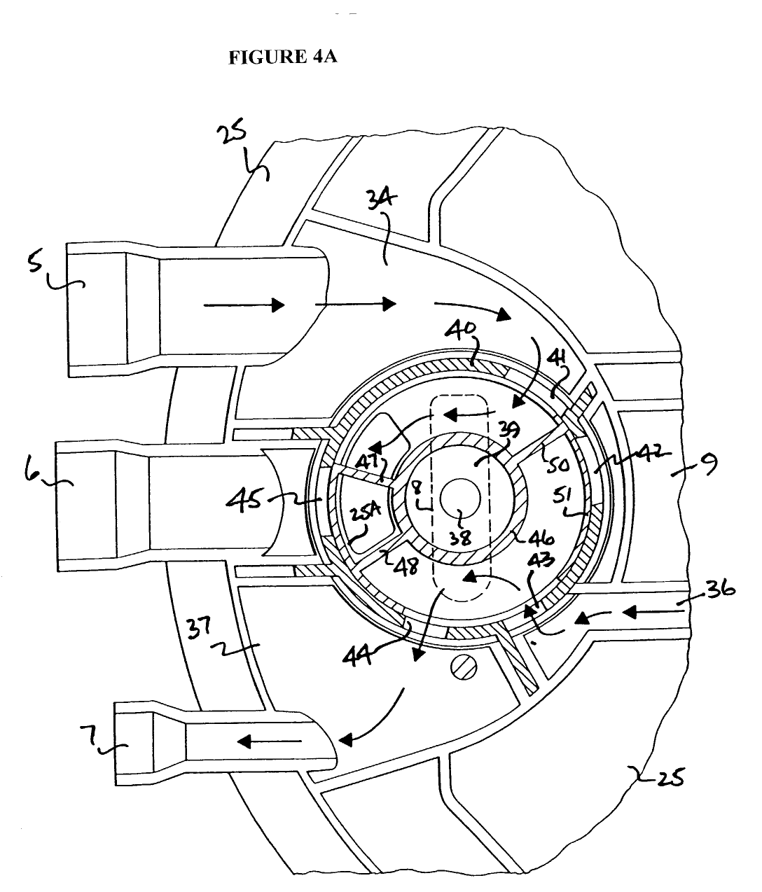

FIG. 4 is a cross section of the filter assembly shown in FIGS. 1 to 3 in its reverse flushing mode showing the compressed filter elements;

FIG. 4A is a cross sectional plan view of the valve shown in FIG. 4 in its reverse flow flushing mode; and

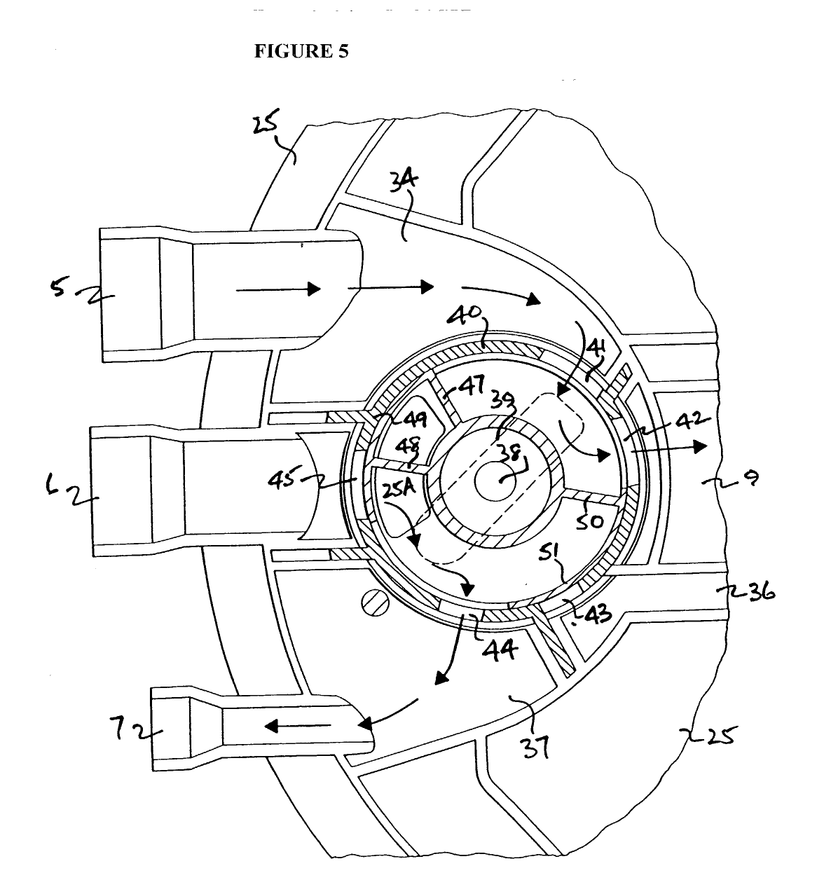

FIG. 5 is a cross sectional plan view of the valve in the filter assembly shown in the previous Figures but in its second stage cleaning mode.

Referring to the drawings and particularly FIG. 1 thereof, there is illustrated a filter assembly of the present invention which comprises a casing 1 having a lid 2 securely attached thereto by means of bolts 3. The casing 1 has a liquid inlet 5, a first liquid outlet 6 and also a second liquid outlet 7. A valve to be described in more detail hereafter is mounted in the lid 2 and has a knob 8 which is rotatable into one of several positions as will be described hereafter.

Referring now to FIG. 2, it can be seen that the casing 1 is generally tapered in cross section and includes tapered sections 1A and 1B. An annular lip 1C surrounds the base of the casing 1. The casing 1 has an arcuate bottom 4. The casing need not necessarily be tapered as illustrated.

Referring now to FIG. 3A, it can be seen that the inlet 5 supplies liquid to anti-chamber 34 from which it travels via ports 41 and 42 in wall 40 in valve member 38 to passage 9 and inlet 9A into a central feed tube 10 (see FIG. 3) which has a plurality of baffles 12 provided around its internal surface. The bottom of the tube 10 narrows at bevelled section 15 to define an outlet 16 spaced from the bottom 4 of the casing 1. A saucer-shaped baffle 17 is positioned directly opposite the outlet 16 for reasons which will be explained shortly. A cigar tube-shaped casing 19 preferably made of quartz is mounted in the main feed tube 10 and is adapted to receive and mount a UV light 20 therein (see FIG. 4).

A floor 26 is rigidly mounted in the casing 1 around the base of the main tube 10. This floor has perforations (not shown) in it to allow the passage of liquid therethrough. The floor 26 is spaced from the bottom 4 of the casing 1 to provide a settlement chamber 18.

A substantially hemispherical bio-filter 27 with slots 29 therein and a lid 28 is slidably mounted on the main tube 10. This bio-chamber is filled, in use, with biological media such as sintered glass.

The top of the casing 1 beneath the lid 2 is closed by a molding which includes a compartment 21 (see FIG. 3) to house various electrical components which do not form part of the invention. The molding also includes a floor 25 in which inlet 9A is formed (see FIGS. 2 and 3) through which water fed from the valve 38 flows into the feed tube 10.

As can be seen more clearly in FIGS. 3 and 4, a movable member or piston 31 and filters 32 and 33 are slidably mounted on the central tube 10, one on top of the other. The bio-filter 27 rests on the piston 31 as shown in FIG. 3 and is designed to make an edge seal with the casing 1 during reverse flow. In FIG. 3 showing normal flow, the piston 31 is bent upwardly out of contact with the casing 1. Upward movement of the bio-filter 27 is limited by the engagement of the lid 28 thereof with undersurface 22 of the chamber 21 which houses the electrics (not shown).

The filters 32 and 33 are preferably made of polyethylene foam but other foam materials could be used.

A sludge pipe 23 extends from the settlement chamber 18 upwardly through the casing 1 on the outside of the main tube 10 to the top thereof where it communicates with sludge return passage 36 leading to valve 38 (see FIGS. 3, 3A and 4).

The valve 38 is better illustrated in FIGS. 3A, 4A and 5 and it can be seen that it comprises a rotatable member having a central core 46 rotatably mounted on valve post 39. The core 46 has arms 47, 48 and 50 extending radially outwardly therefrom. Arms 47 and 48 are connected to an arcuate obturator 49. Arm 50 is connected to an arcuate obturator 51. As can be seen from FIG. 3A, the floor 25 includes an anti-chamber 34, passage 9 and chamber 37. The valve 38 is rotatably mounted on its post 39 and cooperates with wall 40 having ports 41,42,43,44 and 45 therein. The sludge return passage 36 is also formed in the floor 25 and communicates with port 43 in the wall 40. The inlet 5 exits into the anti-chamber 34. The outlet 6 communicates with the outlet port 45 in the valve 38 and the second outlet 7 communicates with the chamber 37.

The operation of the illustrated filter assembly will now be described.

During normal running, water is pumped from the pond by a pump (not shown) and it enters the filter assembly through the inlet 5. The valve 38 will be in its first position shown in FIG. 3A so the water will pass in a first direction through the anti-chamber 34, through the port 41 in the wall 40 and out of the juxtaposed port 42 into the inlet passage 9 as indicated by the arrows. As can be seen in FIG. 2, the inlet passage 9 has an outlet 9A therefrom communicating with the interior of the feed tube 10. The water therefore travels down the feed tube 10 and exits therefrom through the outlet 16. Deflector plate 17 directs the water flow radially outwardly and upwardly into the casing 1 through the filters 32 and 33 which remove contaminant therefrom. The upwardly moving water then travels past the piston 31 and through the slots 29 into the interior of the bio-filter 27 which removes contaminants therefrom and it exits the bio-filter 27 and continues on its upward path to leave the casing 1 through the port 25A in the floor 25. As can be seen from FIG. 3A, the port 25A is wholly open when the valve 38 is in the position illustrated so all of the water flow from the interior of the casing 1 passes through exit port 45 in the wall 40 and into the outlet 6 as indicated by the arrows.

As the water leaves the central tube 10 and is deflected upwardly by the baffle 17, contaminant such as dirt will fall to the bottom of the settlement chamber 18. As the water travels up through the filters 32 and 33, further contaminant is removed from the water flow. As can be seen from FIG. 3, upward axial movement of the piston 31 and filters 32 and 33 is limited due to the bio-filter 27 abutting undersurface 22 of the compartment 21. Filtered water leaving the outlet 6 is returned to the pond in known manner. It should also be noted from FIG. 3A that because the obturator 51 of the valve 38 is blocking off the port 43 in the wall 40, although water can flow from the settlement chamber 18 upwardly through the sludge tube 23 and into the return passage 36, this dirty water and sludge cannot reach the sludge outlet chamber 37 so no water comes out of the sludge outlet 7.

In order to clean the filters 32 and 33 when they become blocked, the valve 38 is moved into its second position shown in FIG. 4A in which the obturator 51 blocks the port 42 in the wall 40. The obturator 49 also blocks off the port 45 leading to the outlet 6 and the leg 47 divides the port 25A in the floor 25 of the valve chamber in half. It will be noted that when the valve 38 is in this position, inlet ports 41 and 43 are open. Outlet port 44 is also open. As shown by arrows, water supplied from the inlet 5 enters the anti-chamber 34 and passes into the interior of the valve 38 via inlet port 41. The only way out of the interior of the valve 38 is through the port 25A in the floor 25 thereof. The water therefore drops through the port 25A into the top of the casing 1 and flows downwardly through the bio-chamber 27 in a second direction and dirt is flushed therefrom.

Water pressure above the piston 31 forces the edge thereof to make a seal with the casing wall, as a result of which it moves axially and it bears down on the filters 32 and 33 and axially squeezes and compresses them. The bio-filter 27 also bears down on the piston and slides down the central tube 10 to the position shown in FIG. 4. This causes dirt and other contaminant to be released from the filters 32 and 33 which collects in the sludge chamber 18. The water then passes upwardly through the casing 1 via the sludge tube 23 (see FIGS. 3 and 4) into the sludge outlet passage 36 (see FIG. 4A). The sludge then travels through the port 43 into the interior of the valve 38 and exits the valve 38 via the port 44 and sludge chamber 37 to the sludge outlet 7. Dirty water exiting the sludge outlet 7 is either pumped into the garden or down a drain. As the obturator 49 on the valve 38 is blocking the outlet 45 in the wall 40, no dirty water can flow out of the outlet 6.

After completion of the reverse flushing of the filters 32 and 33 with the valve in its second position, the valve 38 can then be moved to its third position to complete the cleaning process. The third position of the valve is illustrated in FIG. 5 and it can be seen that ports 41,42 and 44 in the wall 40 are open. Obturator 49 blocks off outlet 45 and obturator 51 blocks off port 43. With the valve in this third position, water enters the filter casing 1 via inlet 5 and passes through the anti-chamber 34 into the valve 38 via port 41. The water exits the valve 38 via port 42 and passes into passage 9 which it leaves via port 9A (see FIG. 3) as has already been described and enters the central tube 10. The water passes down the tube 10 and exits via outlet 16 to pass upwardly through the filters 32 and 33 which expand again and return to their positions shown in FIG. 3. The piston 31 is pushed upwardly which in turn pushes the bio-filter 27 upwardly along the central tube until it abuts the undersurface 22 of the compartment 21 as shown in FIG. 3. The water then exits the casing through the port 25A and enters the interior of the valve 38. The only way out of the interior of the valve 38 is via port 44 as indicated by the arrows so any dirty water in the casing 1 can be flushed out via the sludge outlet 7 and it can be deposited either into the garden or down a drain. Once clean water is seen to be exiting the sludge outlet 7, the operator will know that the filters are now clean and the valve 38 can then be returned to its first position shown in FIG. 3A for normal running. It will be noted that water cannot exit the casing 1 through the sludge pipe 23 which communicates with the sludge exit chamber 36 adjacent the valve 38 because the port 43 from the sludge exit chamber 36 into the interior of the valve 38 is blocked by the obturator 51. Thus, dirty water cannot exit the casing via the outlet 6.

1. A self-cleaning assembly comprising an enclosed casing with a movable member/piston and a filter therein, the casing having an inlet and a first outlet for liquid supplied thereto and a second outlet for removing liquid containing contaminant from the casing, the filter assembly being constructed and arranged to provide, in its normal operating mode, a liquid flow path through the filter in a first direction between the inlet and the outlet and, in a cleaning mode, to provide a liquid flow path in a second direction between the inlet and the second outlet whereby the movable member compresses the filter during the liquid flow in said second direction and contaminant is released therefrom for removal from the filter assembly via the second outlet.

2. A filter assembly as claimed in claim 1 wherein the liquid flow through the casing from the inlet to both outlets is controlled by valve means.

3. A filter assembly as claimed in claim 1 or claim 2 wherein a main tube is provided in the casing to feed liquid from the inlet to the bottom thereof, the main tube having an outlet located adjacent the bottom of the casing.

4. A filter assembly as claimed in claim 3 wherein a deflector is positioned directly opposite the main tube outlet, the deflector being shaped to deflect the liquid flow from the main tube outlet radially outwardly and upwardly into the casing.

5. A filter assembly as claimed in claim 4 wherein the deflector is a saucer-shaped member.

6. A filter assembly as claimed in any of claims 3-5 wherein the main feed tube is located centrally in the casing.

7. A filter assembly as claimed in any of claims 4-6 wherein the casing has a perforated floor spaced from the bottom of the casing to provide a settlement chamber for contaminant flushed from the filter, the main tube outlet opening into said chamber.

8. A filter assembly as claimed in claim 7 wherein the filter rests on the perforated floor but is axially movable in the housing along the main tube.

9. A filter assembly as claimed in any preceding claim wherein the filter comprises a plurality of separate filter elements stacked one on top of each other.

10. A filter assembly as claimed in claim 9 wherein the filter comprises two filter elements.

11. A filter assembly as claimed in any preceding claim wherein the movable member/piston makes an edge seal with the casing during reverse flow.

12. A filter assembly as claimed in claim 11 wherein the movable member/piston is made of a closed cell flexible foam material.

13. A filter assembly as claimed in claim 12 wherein the foam material is neoprene foam.

14. A filter assembly as claimed in claim 10 wherein the each filter element is made of an open cell foam.

15. A filter assembly as claimed in claim 14 wherein the foam material is polyethylene.

16. A filter assembly as claimed in any preceding claim wherein the movable member/piston is made of a rigid material with a flexible seal provided around its periphery.

17. A filter assembly as claimed in any of claims 7-16 wherein a secondary tube extends through the casing and includes means to connect the settlement chamber with the second outlet.

18. A filter assembly as claimed in any of claims 10-17 wherein a movable perforated bio-filter container is mounted around the main and secondary tubes and is slidable therealong, said chamber normally resting on the top filter element.

19. A filter assembly as claimed in claim 18 wherein an abutment is provided in the casing adjacent the upper end thereof to limit axial movement of the perforated container towards the top of the casing.

20. A filter assembly as claimed in any of claims 2-19 wherein the valve means comprises a valve assembly mounted in a chamber in the casing, the arrangement being such that liquid supplied to or leaving the casing is fed through the chamber containing the valve assembly, the chamber having a wall with ports therein and a floor with a port therein communicating with the interior of the casing.

21. A filter assembly as claimed in claim 20 wherein when the valve assembly is in a first position liquid is fed from the inlet to the interior of the casing via ports in the wall of the valve chamber, the port in the floor of the valve chamber allowing liquid to leave the casing and flow to only the first liquid outlet.

22. A filter assembly as claimed in claim 21 wherein the valve assembly is movable to a second position in which liquid from the inlet is fed to the interior of the casing through the port in the floor of the valve chamber, liquid containing contaminant being fed from the interior of the casing to only the second liquid outlet via ports in the valve chamber wall.

23. A filter assembly as claimed in claim 22 wherein the valve assembly is also movable to a third position in which liquid is fed from the liquid inlet to the interior of the casing via ports in the wall of the valve chamber, liquid containing contaminant being fed from the interior of the casing to only the second liquid outlet via the port in the floor of the valve chamber and a port in the wall thereof.

24. A filter assembly as claimed in any of claims 21-23 wherein the valve assembly is rotatably mounted in the valve chamber, the valve assembly having portions movable to obturate the ports in the chamber wall to vary the direction of liquid flow when the valve assembly is in said first, second and third positions.

25. A filter assembly as claimed in any of claims 21-24 wherein the valve assembly also has a portion which splits the liquid flow through the port in the floor of the valve chamber.

26. A filter assembly substantially as herein described with reference to the accompanying drawings.
